(19) United States
(12) Patent Application Publication
(10) Pub. No.: US 2009/0050339 A1
(43) Pub. Date: Feb. 26, 2009

(54) System and method for extinguishing a fire

(76) Inventor: Charles A. Calabrese, Hackensack, NJ (US)

Correspondence Address: Bakos & Kritzer, 27 Laurel Avenue, Summit, NJ, 07901, US

(21) Appl. No.: 11/894,707

(22) Filed: Aug. 21, 2007

(51) Int. Cl. A62C 37/10; A62C 31/00

(52) U.S. Cl. 169/61; 169/70

(57) ABSTRACT

A fire suppression device for attachment to a tree, comprising a tree topper, a smoke and/or flame detection device, an electronic and/or mechanical triggering/actuation device, an extension tube for the transfer of fire suppression material, a reservoir such as a handheld fire extinguisher for extinguishing material including an apparatus for interfacing with the reservoir, and an electrical support system and backup.

### FIELD OF THE INVENTION

The present invention generally relates to the field of fire control. More specifically, the present invention relates to a system and method for controlling or extinguishing a fire in a predetermined area. The identification of high-risk areas coupled with the installation of the system of the present invention enables a user of the present invention to control or extinguish a fire, should a fire ignite within the high-risk area of a personal domicile, workspace, or other area frequented by human beings. More specifically, the present invention is directed to the control, suppressment, and elimination of fires associated with holiday season décor such as Christmas trees.

### BACKGROUND OF THE INVENTION

The need for controlling high-risk fire areas has long been known. It is well known that due to this need, safety organizations such as the National Safety Council universally recommend keeping fire extinguishers in high-risk areas including the kitchen, furnace, garage, and anywhere else a fire may start. Generally, hand-held fire extinguishers have served as the fire control device of choice because such fire extinguishers are generally affordable and easy to use.

As the need for controlling fire in certain predetermined high-risk areas is so pervasive, the United States Patent and Trademark Office is replete with examples of attempts to satisfy this need. To that end, the United States Patent and Trademark Office has examined patent applications purporting solutions for over one hundred years.

Some issued United States patents for common fire prevention inventions include the development of methods and means to retard fires including fire extinguishers, extinguishing chemicals, and fire prevention systems. For example, one early advancement in the art of extinguishing fires in domiciles, workspaces, etc., around the beginning of the twentieth century was the design of an extinguishing sprinkler head. This revolutionary technology is embodied by Lewis U.S. Pat. No. 868,459, which issued on Oct. 15, 1907. The purpose of the disclosed invention, entitled “Sprinkler Head,” was to provide a solution that “under operative conditions direct[ed] water over a certain limited and predetermined area to the exclusion of another area or areas.”

The Lewis invention was designed to be installed in a barn or storage shed in order to protect lines of cars. “Under such conditions the sprinkler heads will be mounted so as to direct water delivered by them away from the wall toward the cars; it being obvious that by this means such water is guided over areas where it is needed, thus avoiding unnecessary waste and consequent low efficiency necessarily resulting from the use of sprinklers of the ordinary construction.”

While the application of Lewis et al. was likely an important disclosure at the time of its issuance, such a primitive disclosure reveals many disadvantages if applied to present fire control wherein specific directed protection is necessary. First, the design of the sprinkler head is directed toward saturation of a particular area and avoidance of saturation of an adjacent area. The sprinkler head is not designed for installation in a particularly high-risk area and is not concealed in any manner. Therefore, the need for a solution that stealthily protects known high-risk areas continues to exist.

High-risk areas, such as kitchens, furnaces, garages, etc., include any area having a higher potential for fires to ignite and/or spread. These areas are generally stationary or constant. That is, in a kitchen, the stovetop area is a high-risk area, and generally the perimeter of that high-risk area does not change on a periodic basis. While these areas are designated high-risk, most extinguishing systems take into account the known risks. Specifically, a homeowner maintains a fire extinguishing device in the kitchen and even positions a smoke detector in a kitchen. In the case of offices including kitchens, sprinkler extinguishing devices are prevalent and sprinklers are directed and concentrated in such stationary areas of high-risk. Such precautions are not so evident in high-risk areas that are not stationary or constant, i.e., areas wherein parameters can change on a predetermined basis based on need or desire.

One high-risk area that is not stationary or constant is the area surrounding a holiday fixture such as a Christmas tree or other apparatus frequently decorated with lighting such as string lighting. Similarly, it is readily recognized that trees located near hotels, restaurants, and the like are adorned at specific times of the year typically with lights as ornamental structures or additional sources of lighting for a facility. Specifically, the area surrounding a Christmas tree or other structure is not stationary because the Christmas tree or structure can adorn different locations during different years, and typically can be moved around a given room during various seasons as the need arises. For example, a Christmas tree may be moved to allow for specific lighting or the stacking or placement of presents beneath it or in the case of a live Christmas tree, the tree may be moved to allow for watering or other treatment. Such movement is important as it yields an increased potential for a fire hazard. For example, in the case of a lighted tree adorned with string lights, movement may lead to chafing of electrical wires. In addition, the movement may cause binding of wires which could lead to overload of the electrical system. Further, movement can lead to arcing of electricity near electrical outlets. Although these hazards which result from the movement of a tree are important causes of fires, the most common cause of fires related to holiday décor is mere human error as people typically overload circuits by the inclusion of too many lighting systems in tandem pulling from a specific electrical source. As a result, since the addition of a Christmas tree in a room is not a stationary object (i.e., it is generally seasonal and subject to repositioning by humans), standard extinguishing systems generally do not take into consideration the additional hazard. Specifically many homeowners do not position smoke detectors near Christmas trees and in most homes fire extinguishing systems are not present. Even if fire extinguishing/sprinkler systems are present in a home, such systems do not often have the capacity (nor are directed to) address the increased fire risk that a tree adorned with electrical lighting brings to the location.

Most people will readily recognize the hazards of maintaining Christmas trees as people are regularly reminded each holiday season by media or other sources of the devastation associated with Christmas tree (or other holiday décor) fires and as such it is well known that the area surrounding holiday décor provides an increased risk for the start and perpetuation of fires. Indeed, the United States Fire Administration warns of the dangers of Christmas Tree Fire Hazards, even providing tips for keeping such fires from spreading. Specifically, the United States Fire Administration warns that “Christmas trees account for 200 fires annually, resulting in 6 deaths, 25 injuries and more than $6 million in property damage.” The United States Fire Administration also cites “ . . . shorts in electrical lights or open flames from candles, lighters or matches” as the most common igniters of Christmas tree fires. In addition, most holiday décor includes warnings reminding users of the potential hazards associated with the use of the décor and in certain instances, such warnings are mandated by the controlling authority.

The need to protect the high-risk area surrounding a Christmas tree from the ignition and spread of fire has long been known. As a result, many attempts have been made to reduce the risks associated with holiday décor fires.

For example, Pappas U.S. Pat. No. 2,682,310 entitled “Christmas Tree Fire Extinguisher” discloses and claims a sprinkler-type system for containing and extinguishing a fire that is ignited or spreading near a Christmas tree.

In disclosing the contemporaneous art and the need for an improved automatic Christmas tree fire extinguisher, Pappas disclosed that “various types of automatic Christmas tree fire extinguishers [have evolved and been] produced by others with a view toward accomplishing the same objective herein under advisement and it is common to this line of endeavor to employ a frangible container for fire extinguishing chemical or liquid and to, in addition, employ fuse controlled means to automatically actuate an impact hammer or the like to fracture the container and cause the extinguishing liquid to shower down over the portions of the tree and to, in this manner, extinguish what might otherwise be a disastrous fire.” In determining the scope of the Pappas invention, Pappas indicated that “an object in the instant matter [is] to structurally, functionally, and otherwise improve upon similarly constructed and performing fire extinguishers in the field of endeavor under consideration.”

In essence, Pappas improved the existing Christmas tree fire extinguishers by providing a stabilizing system to structurally support an ornament-sized ball. The ornament-sized ball was filled with fire extinguishing material.

Referring now to FIG. 1 (PRIOR ART) of the present disclosure, depicted is a schematic of the Pappas invention wherein “the frangible or fracturable container is denoted by the numeral 4 and this may be the size of a fairly large Christmas ball. In practice it will be decorated and colored like a Christmas ball but will differ in that it takes the form of a container for a fire extinguishing liquid and when said container is ruptured the liquid showers down and produces the gases necessary to smother the fire.”

In distinguishing his invention from the prior art, Pappas acknowledges the novelty of only a portion of the disclosed invention. Specifically, Pappas states that “fracturable extinguisher containers are not in themselves new and, therefore, the invention is primarily in the ways and means for supporting and using the container.”

One of the disadvantages associated with the Pappas invention (and much of the field of the art at the time) is the use of a container filled with fire extinguishing material. Indeed, such a configuration limits the utility of such a system to smaller fires.

There are two primary ways to utilize the invention as disclosed by Pappas. First, the Pappas invention can contain a liquid that physically extinguishes the fire. For this system to be effective, the container must be fractured at a location that allows the extinguishing liquid to come in contact with the entirety of the fire. As common knowledge would dictate, this is extremely difficult to manage and direct in such a fashion to extinguish a fire that engulfs an object such as a Christmas tree which is commonly six feet tall and four feet in diameter.

Another way to utilize the Pappas invention would be to fill the frangible container with a liquid that, when exposed to the air outside the container, produces gases which descend or rise to smother the ignited or spreading fire. This is an unacceptable solution because it is heavily dependent upon temperature, air quality, and air flow within the room which is site-specific and fluctuates even at specific sites. As such it is generally impossible to devise a device that can be broadly marketed and safe in various environments.

One further disadvantage with any possible use of the Pappas invention is the quantity limitation inherent in utilizing a frangible container filled with a liquid. Once the container is fractured, one can only hope that the fire is extinguished by the limited contents of the container and it is readily apparent the stage of spread of a fire will dictate the effectiveness of the Pappas device or other like devices.

Yet another disadvantage of the Pappas invention is that the user must attach a specific ornament to a Christmas tree. That is, the Pappas invention is clear in its description of an ornament-sized ball and cannot be utilized or generally modified to coordinate with any preexisting Christmas ornament owned by the user.

Another disadvantage of the Pappas invention is that the disclosed invention cannot be reused in any way, shape or form. More specifically, should the frangible container be fractured, either accidentally or due to the presence of a fire, the user would need to procure another frangible container filled with the appropriate material, and then properly mount the frangible container to protect against future fires.

A final disadvantage associated with the Pappas invention is that the fire extinguishing characteristic of the invention disclosed has no practical uses unless attached to a Christmas tree and would not be practical to protect other trees or apparatus often adorned by string lighting including trees decorated during seasons other than the Christmas season. That is, one who utilizes the Pappas invention would presumably make use of a fire extinguishing material for approximately two months out of every year, and store the fire extinguishing material for ten months out of every year. This is extremely inefficient, as it would greatly benefit the user to be able to utilize a fire extinguishing material throughout the year.

It is clear from analyzing the disclosure of Pappas that the need exists for a fire extinguishing system that can protect against an ignited or spreading fire proximate to a Christmas tree whereby said fire extinguishing system contains more extinguishing material than can fit inside an ornament-sized ball, that can be utilized with preexisting Christmas tree materials (i.e., materials already owned by the user), that has practical use for extinguishing fires throughout the year, and that can be reused from incident-to-incident or year-to-year as necessary.

Another example of the attempts to solve the long-felt need to protect against ignition and spread of fire around a Christmas tree is embodied by Doak U.S. Pat. No. 2,871,952, entitled “Fire Extinguisher.” Importantly, the Doak invention increases the range of prior art Christmas tree fire extinguishers by providing “a novel fire extinguisher of the cartridge type, substantially filled with a fire-extinguishing liquid under pressure and which is provided with a novel valve mechanism facilitating ready and easy charging of the cartridge and expelling of the liquid for extinguishing a fire.”

The Doak invention purports to solve the problem of increasing the probability that an ignited or spreading fire will be extinguished. In particular, the Doak system discloses a specific diffuser for expanding the range of extinguishing material to ensure that the entire Christmas tree is enveloped in liquid capable of retarding flames after a fire is identified.

Specifically, referring to FIG. 2A (PRIOR ART) of the present disclosure, depicted is a section view of the Doak system taken on a vertical plane longitudinally through the disclosed invention. As disclosed, “a hollow frangible stem 15 has an open upper end 15a which projects through the aperture 12 and into the interior of the container, slightly above the valve-seating portion 13. The stem 15 has a transversely outwardly projecting annular flange 16 at the upper end thereof and former integrally thereof and defining a valve element seatable against the valve-seating portion 13 and gasket 14.”

Referring now to FIG. 2B (PRIOR ART), shown is an enlarged detail view of the Doak system depicting the valve mechanism and frangible stem in ruptured condition and wherein the fire extinguishing fluid is being discharged. As exhibited, operation of the Doak invention involves the rupturing of the stem 15 by use of an impact element (e.g., a hammer) 21 which is depicted as an elongated bar with an elongated slot. “The impact element 21 is supported from a plurality of depending frame elements 23 which are interconnected at their upper ends by a ring which encircles the receptacle 11. The peripheral wall 11a of the receptacle has a number of recesses 11b and the interconnecting ring on frame elements 23 has corresponding detents 23a therein which fit into the recesses 11b for holding the frame elements in position.”

Once the ignited or spreading fire has heated the fusible link 25 to 140 degrees Celsius, the fusible link 25 ruptures. “Means are provided for actuating the impact element 21, causing the same to engage and break the stem 15 when the fusible link 25 ruptures. In the form shown, a tension spring 28 is connected to the outer end of the impact element 21 and is connected to the outer side of the container 10 in spaced relation with the receptacle 11. A spring-guided bar 29 extends transversely of the impact element 21 above the spring 23 and is affixed at its opposite ends to adjacent frame elements 23 for guiding the spring and causing the impact element 21 to be urged in a direction transversely of the stem 15.’

Continuing the description of the Doak invention, once the stem 15 is ruptured, the liquid is expelled from the container. More specifically, the “stem 15 will break at the weakened groove 20 and compressed air at 33 in the container and above the liquid will cause the liquid to be expelled through the ruptured stem 15. The expelling liquid will engage the central convex portion 30 of the diffuser and will flow transversally outwardly in multidirections and be diffused upwardly by the convex peripheral portion 21, whereupon the fire extinguishing fluid, which will substantially vaporize and envelop the entire Christmas tree . . . .”

While the Doak system is arguably an improvement over the Pappas disclosure and is further evidence of the need for an extinguishing system as described in the present disclosure, the Doak invention still suffers from several disadvantages hindering its effectiveness. For example, because the Doak invention utilizes a relatively limited cartridge of pressurized liquid of small dimension, it contains an inherent limitation in the quantity of extinguishing liquid present and available to extinguish a fire. The Doak invention would therefore be less effective, or relatively ineffective, against a larger fire. Once the liquid is expelled, the amount of fire protection is limited to the quantity of the contents of the cartridge.

Yet another disadvantage of the Doak invention is that it is self-contained, requiring the attachment of a particular unit to a Christmas tree. More specifically, like the Pappas invention, the Doak invention is specific in its description of an ornament-sized cartridge and cannot be utilized with any preexisting Christmas tree ornaments already owned by the user.

Yet another disadvantage associated with the Doak invention is that the cartridge employed by Doak has no discernable practical use unless attached to a Christmas tree. Specifically, the Doak solution is inefficient because it would likely result in the cartridge—a viable fire extinguishing tool—being stored for much of the year.

Another disadvantage associated with the Doak disclosure is that the cartridge employed by Doak cannot be reused. That is, a part of the design requires the demolition of the cartridge in order to attempt to douse a fire with the liquid contained therein. Therefore, it would be impossible to utilize the cartridge more than once.

It is clear from analyzing the Doak disclosure that the need exists for a fire extinguishing system that can protect against an ignited or spreading fire proximate to a Christmas tree whereby said fire extinguishing system contains more extinguishing material than can fit inside an ornament-sized cartridge, that can be utilized with preexisting Christmas tree materials (i.e., materials already owned by the user), that has practical use for extinguishing fires throughout the year, and that can be reused from incident-to-incident or year-to-year as necessary.

Another attempt at providing a solution for extinguishing ignited or spreading fires in proximity to a Christmas tree is embodied by Jessick U.S. Pat. No. 4,709,763, entitled “Self-Activating Fire Extinguisher.” The Jessick disclosure rests on largely the same principles as the Doak and Pappas invention, namely providing a Christmas ornament containing a fire extinguishing liquid therein. Turning to FIG. 3 (PRIOR ART) of the present disclosure, depicted is the Jessick system exhibiting a cross-sectional view of the self-activating Jessick fire extinguisher in the form of a Christmas tree ornament constructed in accordance with the principles of the disclosed invention. The Jessick specification discloses that “the extinguisher 10 is comprised essentially of a thin-walled glass container 16 which is totally closed and sealed from the outside atmosphere. A quantity of a fire extinguishing liquid 18 is within the container 16. Preferably the container will be approximately three-quarters filled with the liquid 18.”

According to the Jessick system, “the preferred fire extinguishing liquid 18 is Halon 2402 which is available through Montedison USA, Inc. of New York, N.Y.; the chemical composition of which, according to the supplier, is 1.2 dibromo-1.1.2.2. tetrafluoroethane. Halon 2402 has a relatively low boiling point of approximately 47.3.degree. C. When converted into a gaseous state, the fumes are denser than air whereby they tend to settle downwardly and are capable of extinguishing a fire from the source thereof by displacing oxygen.”

Therefore, the general principle of the Jessick invention is that when a fire is present in proximity of the Christmas tree, the fire extinguishing liquid will boil, and thus expand and break the outer surface of the container. Once the container is broken, the fire extinguishing liquid (now in a gaseous state) is released to douse the fire.

However, one of ordinary skill in the art will readily recognize at least one prevalent problem with such a system. Specifically, one existing problem is the need to protect surrounding people and pets from the fragments of glass associated with the explosion of the container. Since the Jessick disclosure is primarily based on the expansion of liquid causing a container to break, it is evident that shards of the container, in this case, glass, may likely create a dangerous environment, especially near a family Christmas tree. However, Jessick attempts to solve this inherent problem by providing a protective layer surrounding the glass portions and maintaining form. Specifically, Jessick discloses the inclusion of “a thin but substantially flexible plastic material 20” for coating “substantially the entire outer surface of the glass container 16” which adheres to the glass container. “The plastic coating 20 is capable of substantially maintaining its shape and physical characteristics and of adhering to the glass container 16 at a temperature above the boiling point of the liquid 18 and above the temperature which is needed for the boiling liquid to cause the container 16 to shatter.” As a result, in the event that the glass container breaks from internal pressure, Jessick argues that the “glass fragments will not be thrown about but will be held substantially in place by the plastic coating 16.” Jessick further discloses that “the self-activating fire extinguisher 10 . . . is suspended from a support such as a Christmas tree or the like utilizing the hook 14. In the event of a fire, the temperature of the liquid 18 rises and the same begins to boil thereby increasing the pressure within the container. Eventually the pressure within the container becomes great enough to cause at least a portion of the glass container 16 to shatter. Since the portion 22 is more frangible than the remaining portions of the glass container. This portion should shatter first. In the event that the remaining portions of the glass container 16 shatter, however, the plastic coating 20 will retain the glass fragments in place. The liquid and fumes from within the container 16 will escape substantially only through the opening caused by the breaking of the portion 22. The fumes will settle downwardly over the tree towards the floor and will extinguish the fire causing the heat.”

Again, while the Jessick invention is arguably a further improved system compared to the aforementioned disclosure, Jessick suffers from similar disadvantages as the Doak and Pappas inventions. First, the effectiveness of the Jessick invention is limited to the minimal quantity of fire extinguishing liquid in the container. Based on the description in the Jessick patent (along with the diagrams embodied by FIG. 3 of the present disclosure) that container is limited to the size of a Christmas ornament.

Another disadvantage associated with the Jessick invention is that the ornament cannot be reused. Likewise, the fire extinguishing component can only be utilized effectively in connection with a Christmas tree. Finally, the Jessick invention requires the use of a particular ornament and cannot be utilized with the preexisting Christmas materials owned by the user.

Further systems are known in the art but each exhibits a series of the aforementioned limitations inherent in the Pappas, Doak, and Jessick disclosures. Therefore, it is evident that the need continues to exist for a fire extinguishing system that can protect against an ignited or spreading fire proximate to a Christmas tree whereby said fire extinguishing system contains more extinguishing material than can fit inside an ornament-sized cartridge, that can be utilized with preexisting Christmas tree materials (i.e., materials already owned by the user), that has practical use for extinguishing fires throughout the year, and that can be reused from incident-to-incident or year-to-year as necessary.

The need to solve these problems is made more evident in view of Barr U.S. Pat. No. 3,171,493 entitled “Fire Protection Devices for Christmas Trees” and Trumbach U.S. Pat. No. 5,031,702, entitled “Fire Extinguishing System for a Christmas Tree.” Specifically, Trumbach acknowledges the need “to provide for extinguishing devices that provide increased fire extinguishing capability and efficiency” which Trumbach describes as its primary object.

First, Barr U.S. Pat. No. 3,171,493 discloses an ornamental device connected to a tank of pressurized fire extinguishing foam which is transferred to the upper portion of a tree in the event of a fire. Specifically, in this instance the fire must reach a degree of heat and expansion in order to rise the temperature of the surrounding air sufficiently to melt “the fusible metal attaching the rods 9 together to permit pressure in the flask to blow the lower rod 9 out of the valve seat 8, thus allowing the fire extinguishing foam to be ejected through the valve seat and impinge against the concave flask base 5 with the resultant deflected downward flow embracing and smothering the tree.” The disclosure further explains, “to ensure complete exhaustion of foam forming liquid from the flask in the case of fire, it is very advantageous to provide an auxiliary cartridge 14 containing gas at higher pressure than the gas pressure in the flask and having a pressure actuated valve connection to the end of the flask opposite to its fluid outlet end.” However, it is clear from the complexity of the required mechanical and chemical reactions that must occur for proper activation of the device that the Barr invention is subject to various defects. Further, it is evident to one of ordinary skill in the art that the Barr device requires sufficient high temperature to fuse the fusible element as a result of a progressed fire that would likely have caused extensive damage by the time the device is activated. Thus, it is clearly desirable to provide for an extinguishing device that provides increased fire protection and swift fire retardation that is quickly activated and operates to extinguish fires efficiently.

Referring now to FIG. 4 (PRIOR ART) of the present disclosure, shown is the elaborate base of the Trumbach fire extinguishing system wherein the base is designed to secure a Christmas tree. Specifically, “the system includes a base 10 for holding a Christmas tree 12 in an upright position and which comprises a non-combustible hollow member 14 forming an internal reservoir for holding a volume of water 21 . . . and thumb screws 16 for engaging and holding the trunk of the tree. The stand is preferably metallic but must be non-combustible and maybe painted, for example the color green, to be esthetically pleasing. Also, although not shown, the base 14 can be provided with additional legs or stabilizing members as desired. Preferably, the base is sized to form a reservoir for holding a volume of water of between about 5 to 10 gallons.”

In addition, “submersible pump 18 having an inlet 19 is mounted within the reservoir and connects to an external conduit 24 by way of piping 22, 26 and, in accordance with a preferred embodiment, a venturi block 20. The venturi block 20 has its low pressure inlet connected to a bulb or container 34 containing any well known fire extinguishing foam material. The fire extinguishing foam and venturi block 20 for extracting and mixing the foam with the water 21 being pumped to the conduit 24 is not a necessity but is preferred as adding an additional measure of fire extinguishing capability to the system. Venturi blocks 20, or ejectors as they are also referred to, for drawing one material into the stream of another material are well known and readily available and operate by connecting the material to be extracted, in the present case the fire extinguishing foam material in container 34, to the low pressure port or low pressure area of the venturi block. In operation, the fire extinguishing foam material will be drawn from the container 34 and intermixed with the water 21 and pumped to the external conduit 24.”

It is therefore clear that Trumbach attempts to solve some of the problems left by such inventions as Pappas and Doak, including the reuse of the invention from incident-to-incident or year-to-year. In addition, the purported five to ten gallon reservoir allows for more fire extinguishing liquid which is an attempt to resolve another disadvantage with prior art systems. While the Trumbach invention provides one solution to those problems, it is a cumbersome and heavy solution at best. In addition, there are several additional disadvantages associated with the Trumbach invention.

One disadvantage associated with the Trumbach disclosure is the size and weight associated with the invention. Further, the invention is presumably limited to the use of water, which would require a user to refill the reservoir periodically due to evaporation.

In addition to the disadvantages inherent in the Trumbach invention, it fails to solve other problems associated with prior art inventions. For example, while water continues to exhibit the same fire-fighting properties throughout the year, it is inefficient to utilize any portion of the system disclosed in Trumbach as a fire-fighting tool at any time other than during the winter holiday season. Its utility is limited to utilizing water as a firefighting substance, which even when mixed with foam provides a dangerous hazard when used in an attempt to extinguish electrical fires.

Therefore, the need exists for a Christmas tree fire extinguisher that is not limited to using water as a firefighting substance, that can be utilized with preexisting holiday décor materials (i.e., materials already owned by the user), and that has practical use for extinguishing fires throughout the year.

### SUMMERY OF THE INVENTION

In view of the foregoing disadvantages inherent in the known and various fire extinguishing devices including those devices commonly developed for use as with holiday décor and decorated trees, including Christmas trees, adorned with string electrical lighting and in some instances trees adorned with devices including open flames such as candles now disclosed in the prior art, in accordance with a first preferred embodiment of the present invention, provided is a fire retardant, suppression and containment device for eliminating and controlling fires in a predetermined region. More specifically, the first preferred embodiment is designed to be utilized to control and ultimately eliminate extensive damage associated with Christmas tree fires.

The primary purpose of the present invention, which will be described subsequently in greater detail, is to provide a first preferred embodiment concerning a Christmas tree fire suppression device for attachment to a Christmas tree, comprising a tree topper of ordinary characteristics (such as toppers manufactured in the form of various stars such as stars of Bethlehem or Christmas stars, angelic symbols, and whimsical toppers such as snowmen, snowflakes, holiday balls, etc., including any combination of the aforementioned symbols), a smoke and/or flame detection device mounted near a plurality of apertures positioned at a lower portion of said tree topper for breathing fumes or detecting flames, an electronic and/or mechanical triggering/actuation device, an extension tube for the transfer of fire suppression material such as retardant foam or other solid, liquid, or gaseous extinguishing material, or any combination thereof, a common reservoir such as a handheld fire extinguisher or reservoir of similar design commonly utilized and available in the art, typically of an automatic design, for said extinguishing material including an apparatus for interfacing with the reservoir, and an electrical support system and backup.

Continuing with the objects of the present invention, in alternate embodiment, disclosed is a fire extinguishing system comprising an integral system manufactured to include a tree topper of ordinary characteristics, a smoke and/or flame detection device, an electronic and/or mechanical triggering device, an extension tube for the transfer of fire suppression material, an integrated and specially designed reservoir, and an electrical support system and backup.

In keeping with the objects of the present invention, a further purpose of the present invention, which will be described subsequently in greater detail, is to provide a second alternate embodiment of a fire extinguishing device employing a sprinkler-type for the effluence of fire extinguishing material for temporarily or permanently mounting to various holiday décor such as an Christmas tree topper or other décor product that may be susceptible to increased fire risk.

In the aforementioned preferred and alternate embodiments, it will be readily apparent to those of ordinary skill in the art that various fire extinguishing agents and systems may be utilized in accordance with objectives of the invention disclosed herein. Specifically, it is preferred that portable fire extinguishers containing fire extinguishing material commonly utilized for National Fire Protection Association (NFPA) designated Class A (ordinary combustibles) and/or Class C (energized electrical equipment), or combination thereof may be utilized. Generally, materials utilized for these types of fires include water, foam, dry powder, carbon dioxide, halon, or wet chemical in various propositions as commonly known in the art.

Thus, there has been summarized and outlined, generally in broad form, a plurality of the most important features of the present invention, as described with respect to the foregoing preferred and alternate embodiments, in order that the following detailed description thereof which follows may be better understood by one of ordinary skill in the art. This summary and outline is further presented so that the novelty of the present contribution to the related art may be better appreciated. It will further be apparent that additional features of the invention described hereinafter and which will form the subject matter of the claims appended hereto will further define the scope, novelty, and in certain instances the improvements upon any existing art.

Further, it is to be readily understood that the invention presented herein is not limited in its application to the details of construction and to the arrangements of the components set forth in the following description or illustrated in the various figures integrated and categorized herein. The scope of the disclosure is presented in broad form so that other objects, features, and characteristics of the present invention, as well as the methods of operation and functions of the related elements of the structure, and the combination of parts and economies of manufacture, will become more apparent upon consideration of the following detailed description.

Those skilled in the art will appreciate that the disclosure of the present invention may readily be utilized as a basis for the designing of other similar structures, methods and systems for carrying out the various purposes and objectives of the present invention. Thus, the claims as set forth shall allow for such equivalent constructions insofar as they do not depart from the spirit and scope of the present invention as described herein.

It is therefore an object of the present invention to provide a system and method for extinguishing fires that occur in proximate physical relation to a Christmas tree.

One further object of the present invention is to provide a system and method which provides for a concealed fire extinguishing system in order to preserve the decorative nature of a Christmas tree.

Another object of the present invention is to provide a system and method that is capable of extinguishing larger fires in proximate physical relation to a Christmas tree. Specifically, the system and method of the present invention utilize a container which maintains a large capacity to carry fire extinguishing materials.

Another object of the present invention is to provide a system and method that can be utilized to extinguish fires that occur in proximate physical relation to any Christmas tree, whether such Christmas tree is natural or artificial.

It is yet another object of the present invention to provide a system and method that can be utilized to extinguish fires that occur in proximate physical relation to a Christmas tree by incorporating materials (e.g., an existing fire extinguisher) owned by the user.

Yet another object of the present invention is to provide a system and method that can be utilized to extinguish fires that occur in proximate physical relation to a Christmas tree, wherein the container storing the fire extinguishing material can be utilized as a fire extinguisher throughout the year.

It is an additional object of the present invention to provide a system and method that can be utilized to extinguish fires that occur in proximate physical relation to a Christmas tree, wherein the system can be reused from year-to-year or incident-to-incident.

It is another object of the present invention to provide a system and method that can be utilized to extinguish fires that occur in proximate physical relation to a Christmas tree, wherein the system can be easily and efficiently manufactured and marketed.

It is a further object of the present invention to provide a system and method that can be utilized to extinguish fires that occur in proximate physical relation to a Christmas tree, wherein the system is of a durable and reliable construction.

An even further object of the present invention is to provide a system and method that can be utilized to extinguish fires that occur in proximate physical relation to a Christmas tree, wherein the system can be economically available to the buying public.

Still yet another object of the present invention is to provide a new self-contained, replaceable fire extinguishing tree ornament which provides in the apparatuses and methods of the prior art some of the advantages thereof, while simultaneously overcoming some of the disadvantages normally associated therewith.

### BRIEF DESCRIPTION OF THE DRAWINGS

A further understanding of the present invention and the objectives other than those set forth above can be obtained by reference to the various embodiments set forth in the illustrations of the accompanying figures. Although the illustrated embodiment is merely exemplary of systems for carrying out the present invention, both the organization and method of operation of the invention, in general, together with further objectives and advantages thereof, may be more easily understood by reference to the drawings and the following description. The figures are not intended to limit the scope of this invention, which is set forth with particularity in the claims as appended or as subsequently amended, but merely to clarify and exemplify the invention. The detailed description makes reference to the accompanying figures wherein:

FIG. 1 (PRIOR ART) depicts a schematic of the Pappas U.S. Pat. No. 2,682,310 prior art entitled “Christmas Tree Fire Extinguisher” wherein a frangible or fracturable container, generally the size of a relatively large Christmas ball is denoted by the numeral 4.

FIG. 2A (PRIOR ART) depicts a schematic of the Doak U.S. Pat. No. 2,871,952 prior art entitled “Fire Extinguisher” wherein a section view of the Doak system taken on a vertical plane longitudinally through the disclosed invention is presented.

FIG. 2B (PRIOR ART) depicts a schematic of the Doak U.S. Pat. No. 2,871,952 prior art entitled “Fire Extinguisher” wherein an enlarged detail view of the Doak system depicting the valve mechanism and frangible stem in ruptured condition and wherein the fire extinguishing fluid is being discharged is detailed.

FIG. 3 (PRIOR ART) depicts a schematic of the Jessick U.S. Pat. No. 4,709,763 prior art entitled “Self-Activating Fire Extinguisher” exhibiting a cross-sectional view of the self-activating Jessick fire extinguisher in the form of a Christmas tree ornament.

FIG. 4 (PRIOR ART) is a schematic of the Trumbach U.S. Pat. No. 5,031,702 prior art entitled “Fire Extinguishing System for a Christmas Tree” prior art entitled “Self-Activating Fire Extinguisher” depicting the elaborate base of the Trumbach fire extinguishing system wherein the base is designed to secure a Christmas tree.

FIG. 5 is a schematic of the front perspective view of preferred embodiment of the present invention wherein the fire extinguishing apparatus adorns a Christmas tree.

FIG. 6 is an expanded view of the preferred embodiment of the tree fire suppression device as depicted in FIG. 5.

FIG. 7 depicts a front perspective view of an alternate embodiment of the present invention comprising a single tree fire suppression device exhibiting an entirely closed system with an integral dispensing reservoir.

FIG. 8 is a cut-away view of a schematic perspective view of a tree topper utilized as a portion of the tree suppression devices depicted in FIG. 5, FIG. 6, and FIG. 7 of the preferred and alternate embodiments of the present disclosure.

FIG. 9 depicts a front perspective view of a further alternate embodiment of a fire extinguishing device employing a sprinkler-type outlet for the effluence of fire extinguishing material.

FIG. 10 is an expanded view of the alternate embodiment disclosed in FIG. 9 depicting a fire extinguishing device employing a sprinkler-type outlet for the effluence of fire extinguishing material.

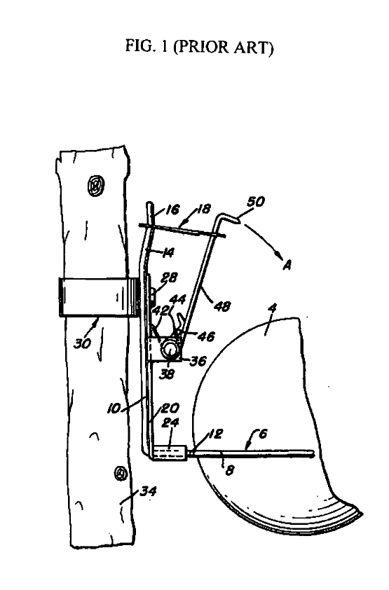

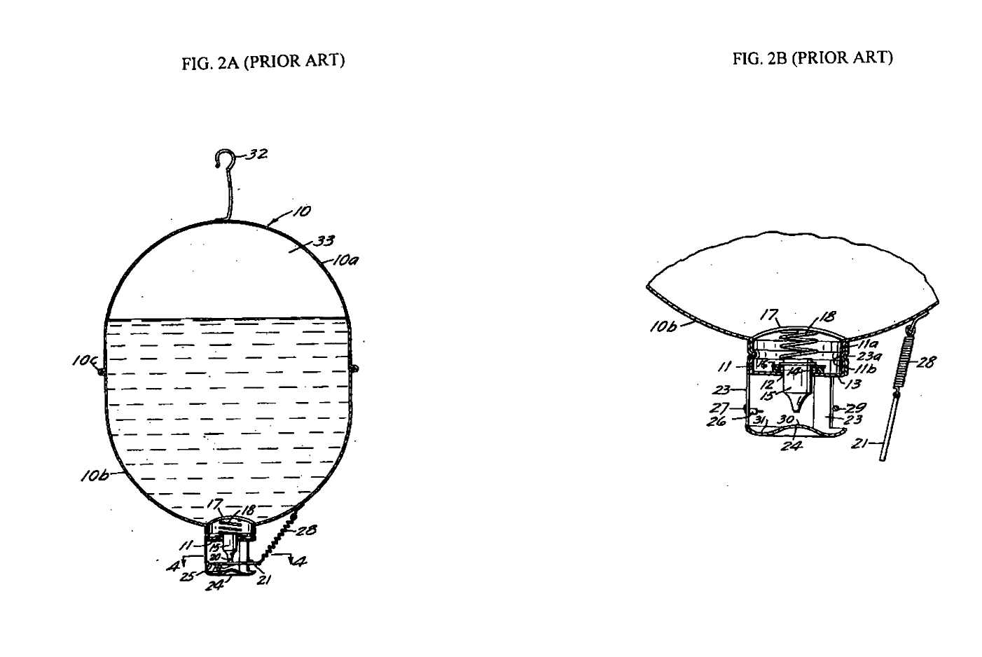

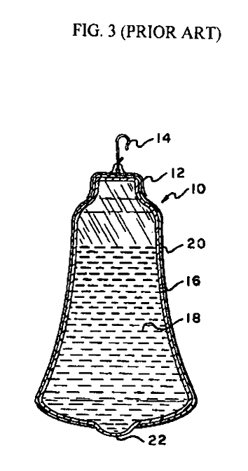

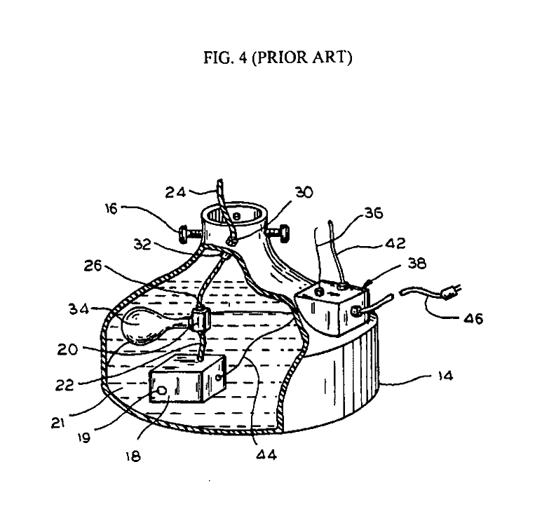

### DETAILED DESCRIPTION OF THE PREFERRED EMBODIMENT

A detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention. The following presents a detailed description of a preferred embodiment (as well as some alternative embodiments) of the present invention.

Moreover, well known methods, procedures, and substances for both carrying out the objectives of the present invention and illustrating the preferred embodiment are incorporated herein but have not been described in detail as not to unnecessarily obscure novel aspects of the present invention.

Referring first to FIG. 5, depicted is the preferred embodiment of the present invention wherein the fire extinguishing apparatus adorns a Christmas tree. Christmas tree fire suppression device 500 is attached to Christmas tree 502 at various points with hooks, wire, or other known attachment means and portions of the extinguishing hose rest on limbs of the Christmas tree to provide further support. While tree fire suppression device 500 is depicted as adorning an evergreen tree of artificial construction, it will be readily apparent that the fire suppression device may be utilized for natural evergreen trees or any other type of holiday décor that may require additional fire protection due to its construction, inherent characteristics, or placement in an area of fire risk.

Tree fire suppression device 500 of the present invention comprises tree topper 504. Tree topper 504 is manufactured of ordinary characteristics and common dimensions so as to discretely hide the fire retardant nature of the device while not departing from the aesthetic attributes common with tree toppers. In accordance with the preferred embodiment of the invention, tree topper 504 is manufactured in the form of a single pointed star with circular portion and integrated lower skirt, however, tree topper 504 may be manufactured in the form of various stars such as stars of Bethlehem or Christmas stars, angelic symbols, and whimsical toppers such as snowmen, snowflakes, holiday balls, etc., including any combination of the aforementioned symbols while keeping within the spirit of the present invention.

In the preferred embodiment as depicted by FIG. 5, several smoke and/or flame detection apertures are evident. Specifically, a plurality of smoke/flame detector apertures 506 positioned within tree topper 504 are within close proximity and linked to smoke/flame detection mechanism resident within tree topper 504. In this embodiment, the smoke/flame detection mechanism is positioned at a lower housing of tree topper 504 for breathing fumes or detecting flames and is further linked to internal trigger mechanism of tree fire suppression device 500. Optional smoke detector and/or flame detector devices 510 are linked at various points within the system. Specifically, in the preferred embodiment, smoke detector and/or flame detector devices 510 are attached to extension tube 512. Extension tube 512 is designed and manufactured to allow the transfer of fire suppression material such as retardant foam or other solid, liquid, or gaseous extinguishing material, or any combination thereof. In the preferred embodiment, extension tube 512 is designed of sufficient length to wrap and adorn Christmas tree 502. Extension tube 512 is also decorated in typical holiday hues and designs so that it provides an aesthetic benefit to Christmas tree 502 similar to that of common garland. It is also contemplated that extension tube 512 can be used to mimic garland, popcorn string, ribbon, or other like décor. In the alternative, it is contemplated by the present disclosure that extension tube 512 may be designed to be hidden within the branches of Christmas tree 502 and/or manufactured to attach to any internal portion of Christmas tree 502 such as the trunk. As another alternative, it is contemplated that extension tube 512 may be designed to be hidden among and within portions of an artificial tree, including but not limited to a hollow trunk.

Extension tube 512 is connected to tree topper 504 at its upper end and common reservoir 514 at the lower end. Through the use of an actuation mechanism integral with tree fire suppression device 500, fire suppression, extinguishing, and/or retardant material is transferred from common reservoir 514 through integrator nozzle 516 to tree topper 504 and diffused through sprinkler portals 508 of tree topper 502. A backup actuator 518 is further provided at common reservoir 514 to provide for manual operation of tree fire suppression device 500.

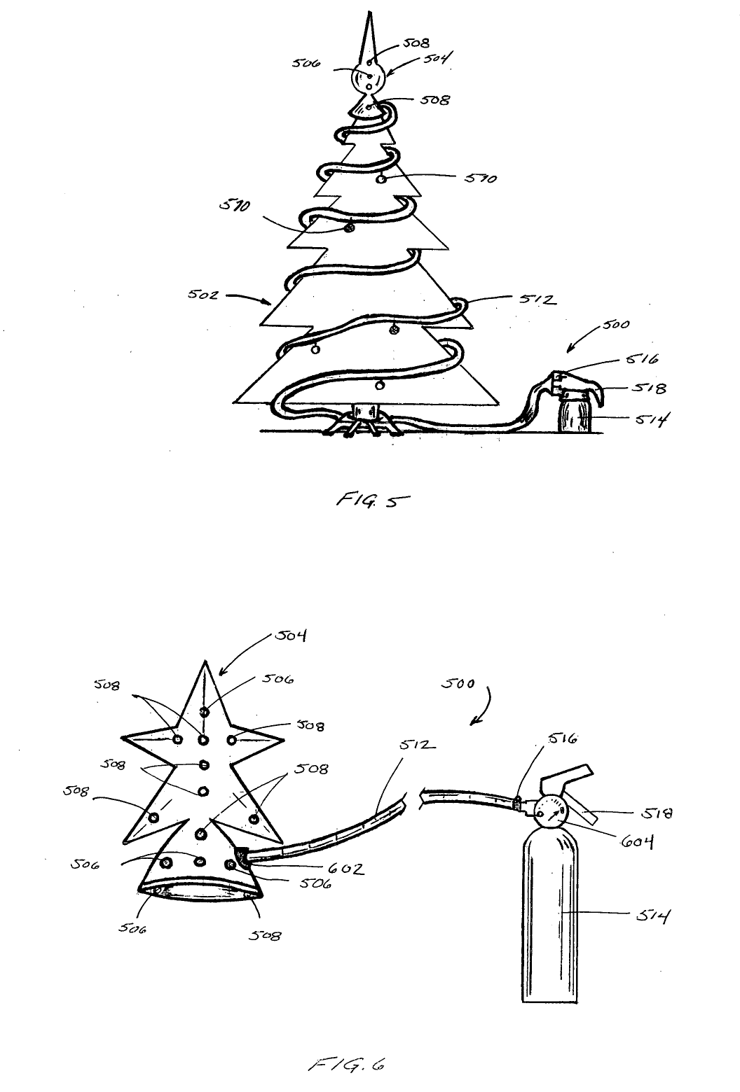

Turning next to FIG. 6, depicted is an expanded view of the preferred embodiment of the tree fire suppression device 500 as depicted in FIG. 5. Tree topper 504 is manufactured in a five pointed star arrangement and includes a plurality of sprinkler portals 508 for diffusing extinguishing material and smoke/flame detector apertures 506. Depending on the size and shape of tree topper 504, various configurations of sprinkler portals 508 and smoke/flame detector apertures 506 may be employed while keeping within the scope and objects of the present invention. Sprinkler portals 508 are manufactured in accordance with common industry standards to allow for the spreading of extinguishing material upon activation of the tree fire suppression device and may further be designed and aligned in various configurations to allow the proper and desired spray so that a substantial portion of the tree and in some instances the surrounding area receive extinguishing material upon activation. The design of the present invention contemplates for sprinkler portals 508 and smoke/flame apertures 506 to be tilted in a direction (e.g., downward, sideward, etc.) in order to better enhance protection with regard to specific high-risk areas.

According to FIG. 6, extension tube 512 (shown at fractured length for ease of reference) is connected to lower portion of tree topper 504 via access portal 602. Access portal 602 is manufactured of particular size and shape to allow for proper integration of extension tube 512 which is secured so that when the system of the present invention is activated and pressurized, extension tube 512 remains attached allowing for proper flow to internal diffuser connected to said plurality of sprinkler portals 508. As depicted, lower end of extension tube 512 is connected to integrator nozzle 516, which is manufactured to attach extension tube 512 to common reservoir 514 and is produced of sufficient grade material allowing for substantial pressurized material to pass therethrough. Further, integrator nozzle 516 is designed to adapt to the various mechanisms employed in the art (including without limitation: hand-held fire extinguishers, stationary extinguishers, can extinguishers with aerosol propellants, and many others) for dispelling fire extinguishing materials. In the preferred embodiment, it is recognized that common reservoir 514 is a widely available fire extinguisher comprised of a cylindrical metal, commonly aluminum, construction pressurized with an extinguishing agent and further including gauge 604 for depicting the status of contents and backup actuator 518 allowing manual operation of the system. It will be readily recognized in the art that various extinguishing components may be utilized to pressurize the vessel, however, it is preferred that multipurpose extinguishing materials are utilized. Thus, suppression material such as retardant foam or other solid, liquid, or gaseous extinguishing material, or any combination thereof may be utilized, especially those extinguishing materials known in the art for addressing Class A and Class C fire. For example, depending on the desired application, while the following list is not intended to be exhaustive and is intended to include equivalents thereof including such substances not yet developed that achieve the goal of extinguishing and limited fires, dry chemicals, foams, wet chemical, waters, or clean agents may be commonly utilized.

As one example of such fire extinguishing material, one common dry chemical agents that is currently employed in the art includes ammonium phosphate. Ammonium phosphate is generally used on class A, B, and C fires. It receives its class A rating from the agent's ability to melt and flow at 350 degrees to smother fire. A second example is sodium bicarbonate. Sodium bicarbonate is designed for use on class B and C fires as it is designed to interrupts the fire's chemical reaction. Potassium bicarbonate is a third chemical agent used on class B and C fires.

Foam extinguishing materials include synthetic, water based foams called “aqueous film forming forms” (“AFFF”). AFFF are water-based foams, frequently containing alpha-olefin sulfonates, and/or perfluorooctane sulfonate (PFOS) and perfluorooctanoic acid (PFOA) as surfactants and are typically used on Class A and Class B fires and for vapor suppression.

Wet chemical agents include examples such as potassium acetate. Potassium acetate extinguishes the fire by forming a crust over certain Class A fires.

Water is a proven retardant. A common water-based extinguisher includes APW (air pressurized water) systems. This water-based system cools burning material by absorbing heat. While water is generally effective on only Class A fires it has the advantage of being inexpensive, harmless, and relatively easy to clean up.

Specific clean agents that may be utilized, and are generally preferred for the present application include Halotron, FE-36, carbon dioxide, or other mixtures of inert gases. Generally, these gaseous agents disrupt the chemical reactions of a fire or smothers the fire. These clean agents are generally classified as Class A, B, and C retardants.

Of course, while the preceding disclosure enumerates several examples of types of fire extinguishing material, it should be readily appreciated by one of ordinary skill in the art that any substance capable of extinguishing a fire can be utilized in accordance with the present invention without departing from the scope of objectives thereof.

In addition, in the preferred embodiment as depicted in FIG. 6 common reservoir may be any general extinguishing system that automatically propels the aforementioned extinguishing material and can be integrated with the existing system. For example, certain extinguishing systems incorporated herein by reference include Haggard U.S. Pat. No. 3,719,231 entitled “Attachment for Automatic Override of Manually Operated Compressed Gas Fire Extinguishers and Alarms.” It is evident that the automatic modification to the handheld manual fire extinguisher described by Haggard can be adopted and integrated with the present system. Further, it will be readily apparent to those of ordinary skill in the art that the Haggard system can be modified so that upon detection of an alarm condition by a smoke/detector apparatus located within in tree topper 504, the fire extinguisher can be automatically actuated by electronic means rather than the physical automatic actuation disclosed by Haggard. In another example, Kirchner U.S. Pat. No. 4,527,635 entitled “Automatic Fire Extinguishing Apparatus” may be employed with the present invention to allow for the automatic operation of a common fire extinguisher. One of ordinary skill in the art will recognize that the fusible material utilized by Kirchner could be positioned within tree fire suppression device 500 to allow for automatic operation.

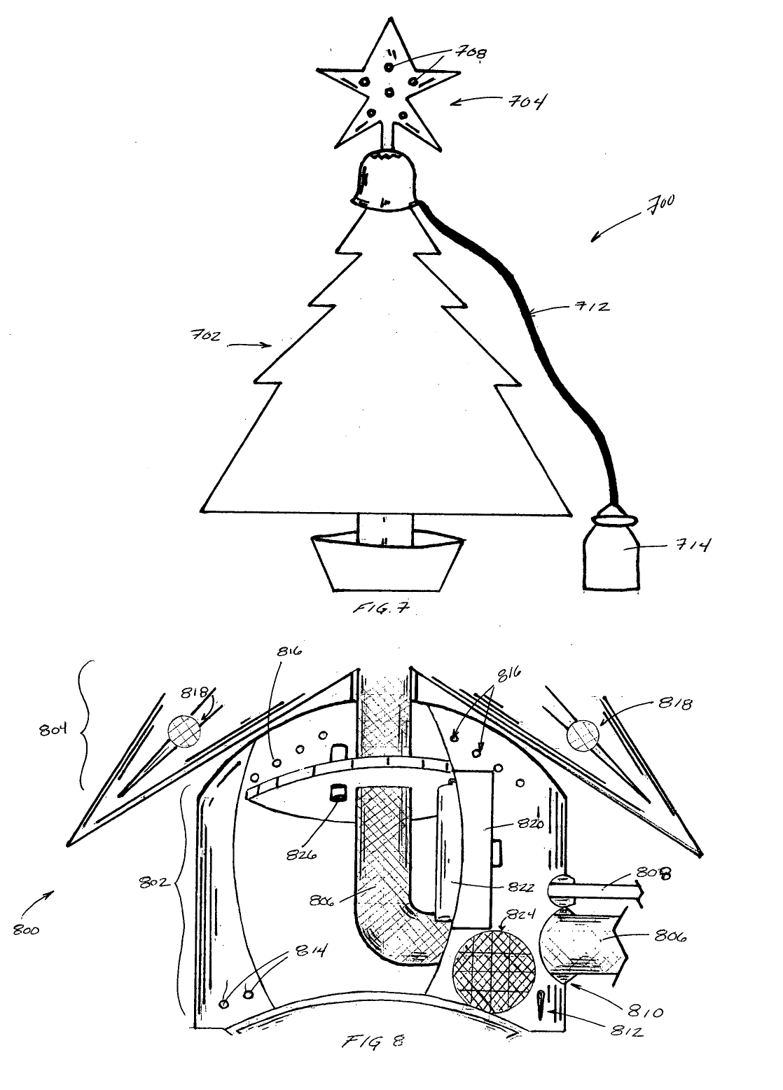

Turning next to FIG. 7, depicted is an alternate embodiment in accordance with the present invention. In contrast to the preferred embodiment addressed in FIG. 5 and FIG. 6, the present alternate embodiment comprises a single tree fire suppression device 700 exhibiting an entirely closed system with a unique integral dispensing reservoir 714, preferably offered as a one piece unit. Similarly to the previous figures, fire suppression device 700 comprises tree topper 704 of ordinary characteristics including sprinkler portals 708, stealth smoke and/or flame detection device (not shown), electronic and/or mechanical triggering device within tree topper 704 (not shown), extension tube 712 for the transfer of fire suppression material, integrated and specially designed reservoir 714, and electrical support system and backup.

Referring to FIG. 8, depicted is a cut-away of a schematic perspective view of a tree topper utilized as a portion of the tree suppression devices depicted in FIG. 5, FIG. 6, and FIG. 7 of the preferred and alternate embodiments of the present disclosure. Tree topper 800 includes upper portion 804 manufactured in the shape of standard tree toppers and lower portion 802 for stealthly integrating the components of the system and for securely mounting tree topper 800 to the tree. Upper portion 804 of tree topper 800 comprises a standard novelty design such as a pointed star as well as point of emission, sprinkler portals 818, for diffusing extinguishing liquid. In this alternative embodiment of the present invention, sprinkler portals 818 further comprise grate portions to further diffuse extinguishing material and direct same in desired direction.

Lower portion 802 of tree topper 800 is manufactured of a concentric or conical shape to allow for proper adornment of the top of a tree and may further include attachment mounts for securely attaching to the tree. In this example, access portal 810 is manufactured of particular size to allow for proper integration of extension tube 806 which is secure so that when the system is activated and pressurized, extension tube 806 remains attached allowing for proper flow to internal diffuser connected to said plurality of sprinkler portals 818 of upper portion 804 of tree topper 800. Extension tube 806 is manufactured of reinforced material known in the art and is secured within tree topper 806 so as to further eliminate movement upon pressurization of the system.

Lower portion 802 of tree topper 800 includes smoke/flame detector apertures 814 to allow for heat, flame, or smoke to enter enclosed lower portion 802 of tree topper 800 so that such matter will activate fire detector 826 thereby triggering an internal alarm and circuit switch for activating fire suppression device and altering the valve mechanism so that fire extinguishing liquid enters system. Further, lower portion 802 of tree topper 800 includes audible alarm 824 for notification of activation of system and presence of fire, heat, and/or smoke. Although mechanical versions of the present invention are contemplated, activated by the melting of a fusible member and expansion of extinguishing materials, the present example is designed with direct household electrical supply 808 as well as backup power supply, battery 822, hidden by battery cover 820. Power supply is designed to activate circuit control (not shown) as well as charge audible alarm and fire detector 826. Finally, LED power switch 812 located within lower portion 802 of tree topper 800 provides evidence of a charged system to a user.

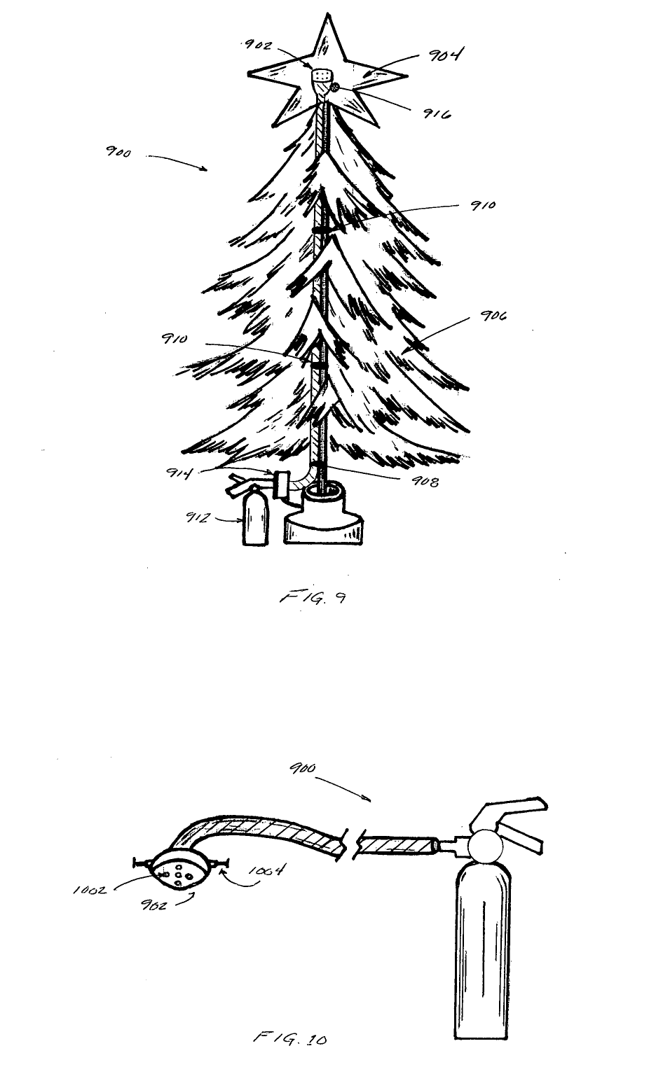

Referring next to FIG. 9, provided is yet another alternative embodiment of a fire extinguishing device 900 employing a sprinkler-type outlet 902 for the effluence of fire extinguishing material. Fire extinguishing device 900 is designed for temporarily or permanently mounting to various holiday décor such as Christmas tree topper 904 or other décor product that may be susceptible to increased fire risk. In the present embodiment, extension tube 908 is generally hidden from view and attached to trunk of holiday tree 906 via attachment means 910 such as ties, screws, wraps, clips, etc. Upon notification of the presence of smoke and/or fire via integrated detectors 916, activation is triggered and extinguishing material is transported from extinguisher 912 through electrically integrator adapter 914 upwards within extension tube 908 to sprinkler-type outlet 902 attached at the underside of tree topper 904 or on backside of tree topper 904 so that sprinkler type outlet is hidden from view thereby not altering the aesthetics of Christmas tree.

FIG. 10 provides a detailed and unobstructed perspective view of the alternate embodiment disclosed in FIG. 9. Fire extinguishing device 900 is manufactured in accordance with the principles of the various embodiments disclosed in the present invention and includes the further modification of a sprinkler-type outlet 902. Sprinkler-type outlet 902 is depicted with a plurality of apertures 1002 for diffusing extinguishing material. Apertures 1002 may be directed in any particular fashion to effectuate the proper dispensing of extinguishing material. Sprinkler-type outlet 902 further includes head fasteners 1004 for adhering sprinkler-type outlet to tree topper of upper portion of tree.

The foregoing description of the embodiments have been set forth in considerable detail for the purpose of making a complete disclosure of the present invention. It will be appreciated by those skilled in the art that changes could be made to the embodiments described above without departing from the broad inventive concept thereof. It is understood, therefore, that this invention is not limited to the particular embodiments disclosed, but it is intended to cover all modifications that are within the scope and spirit of the invention as defined by the appended claims.

Therefore, what is claimed is:

1. A fire suppression system for attachment to a Christmas tree comprising:
a tree topper;
a smoke detection device mounted near a plurality of apertures positioned at a lower housing of said tree topper;
a flame detection device mounted near a plurality of apertures positioned at a lower housing of said tree topper;
a heat detection device mounted near a plurality of apertures positioned at a lower housing of said tree topper;
an extension tube for the transfer of fire suppression material;
an electronic actuation device for activating release of said fire suppression material;
an electrical support system; and
a common reservoir
wherein said common reservoir is a handheld fire extinguisher with an automatic activation system.

2. The fire suppression system according to claim 1 wherein said fire suppression material is selected from the group of water, foam, dry powder, carbon dioxide, halon, or wet chemical.

3. The fire suppression system of claim 1 wherein said tree topper is generally ornamental and is selected from the group stars, angelic symbols, whimsical toppers, snowmen, snowflakes, or holiday balls.

4. The fire suppression system of claim 1 wherein said electrical system further includes a backup electrical system.

5. The fire suppression system of claim 1 wherein said smoke detection device, said flame detection device, said flame detection device are a single detection unit.

6. The fire suppression system of claim 5 wherein said single detection unit activates an acoustic alarm.

7. The fire suppression system of claim 5 wherein said single detection unit activates a control circuit capable of triggering a circuit switch for activating fire suppression device and altering the valve mechanism so that fire extinguishing liquid enters system from said common reservoir.

8. A fire suppression system for attachment to a Christmas tree comprising:
a tree topper;
a smoke detection device mounted near a plurality of apertures positioned at a lower housing of said tree topper;
a flame detection device mounted near a plurality of apertures positioned at a lower housing of said tree topper;
an electronic actuation device;
a heat detection device mounted near a plurality of apertures positioned at a lower housing of said tree topper;
an extension tube for the transfer of fire suppression material;
fire suppression material;
an electrical support system;
a common reservoir; and
a control circuit capable of triggering a circuit switch;
wherein said circuit switch activates a fire suppression device and alters a valve mechanism so that fire extinguishing liquid enters from said common reservoir.

9. The fire suppression system of claim 8 wherein said fire suppression material is selected from the group of water, foam, dry powder, carbon dioxide, halon, or wet chemical.

10. The fire suppression system of claim 8 wherein said tree topper is generally ornamental and is selected from the group stars, angelic symbols, whimsical toppers, snowmen, snowflakes, or holiday balls.

11. The fire suppression system of claim 8 wherein said electrical system further includes a backup electrical system.

12. The fire suppression system of claim 8 wherein said smoke detection device, said flame detection device, said flame detection device are a single detection unit.

13. The fire suppression system of claim 8 wherein said single detection unit activates an acoustic alarm.

14. A fire suppression system for attachment to a tree comprising:
a smoke detection device;
a plurality of apertures for diffusing extinguishing material;
an integrated flame and smoke detection device;
an actuation device;
an extension tube for the transfer of fire extinguishing material;
an electrical support system; and
a reservoir from maintaining fire extinguishing material.

15. The fire suppression system of claim 14 wherein said fire extinguishing material is selected from the group of water, foam, dry powder, carbon dioxide, halon, or wet chemical.
